(19) United States
(12) Patent Application Publication
(10) Pub. No.: US 2013/0186740 A1
(43) Pub. Date: Jul. 25, 2013

(54) Method and Apparatus for Water Distillation

(71) Applicant: Rune Midttun, Fyllingsdalen (NO)

(72) Inventor: Rune Midttun, Fyllingsdalen (NO)

(73) Assignee: ATLANTIC WATER CO. LIMITED, Newmachar, Aberdeen (GB)

(21) Appl. No.: 13/321,729

(22) PCT Filed: May 19, 2010
(86) PCT No.: PCT/GB2010/001004

§ 371 Date: Mar. 26, 2013

(30) Foreign Application Priority Data
May 21, 2009 (GB) 0908736.2

(51) Int. Cl. C02F 1/16

(52) U.S. Cl. CPC C02F 1/16
USPC 203/10; 202/180

(57) ABSTRACT

Apparatus for use in distilling water, comprising a heating arrangement (20) for heating incoming water and thereby producing steam, a condensing arrangement (26) in a flow path of the steam from the heating arrangement (20) for producing condensed water from the steam, the arrangement being such that thermal energy from the condensing steam can be employed to heat the incoming water in the heating arrangement (20). The apparatus further comprises a pre-heating arrangement (16) upstream of the heating arrangement (20) in the flow path of the incoming water and in the flow path of the condensed water from the condensing arrangement (26) for transferring thermal energy from the condensed water to the incoming water.

This invention relates to a method of distilling water and to an apparatus for use in such method.

U.S. Pat. No. 4,724,048 discloses a water distilling apparatus for purifying and degassing domestic water supplies. It is intended to be constructed for easy cleaning of all parts. Inflowing water is preheated by-condensing steam within a condenser, which preheating allows dissolved gases to dissipate through a vent before the inlet water reaches an evaporator portion. The rate of inflowing water is controlled by a temperature-responsive valve that is in thermal communication with the condenser to maximize heat transfer and minimize heat and water loss.

U.S. Pat. No. 4,946,558 discloses a water distiller which is used in conjunction with a hot water heater where normally wasted energy is used to preheat the hot water heater inlet. The distiller includes a heat storage tank, an evaporator tank having a water inlet, a heater and a steam outlet, and first and second heat exchangers located within the heat storage tank. Steam generated in the evaporator tank passes through the first heat exchanger and condenses, forming distilled water. The heat rejected during condensation is absorbed within the heat storage tank. The second heat exchanger is used to preheat the water flowing to the hot water heater inlet by passing the water through the second heat exchanger on an as needed basis where it absorbs heat from the heat storage tank.

WO-A-2009/000016 discloses a desalination process comprising heating brine in a preheating chamber and transferring the brine to a rotary kiln to be sprayed against the wall structure of the rotary kiln to boil to steam and a residue of salt and other impurities, the exiting steam being pressurised in a compressor and passed to an externally powered heater to be heated and then fed to a hollow wall structure of the rotating kiln in which the steam condenses to pure water to be transferred to the preheating chamber to preheat the incoming brine, the rotating kiln being arranged to rotate past a scraper to remove salt and other impurities from the wall structure for collection at the base of the kiln.

According to one aspect of the present invention, there is provided a method of distilling water, comprising heating incoming water to produce steam, condensing the steam to produce condensed water and utilizing the thermal energy produced by said condensing to perform said heating.

According to another aspect of the present invention, there is provided apparatus for use in distilling water, comprising a heating arrangement for heating incoming water and thereby producing steam, a condensing arrangement in a flow path of said steam from said heating arrangement for producing condensed water from said steam, the arrangement being such that thermal energy from the condensing steam can be employed to heat said incoming water in said heating arrangement.

Owing to the invention, it is possible, compared with a system in which there is no heating of the incoming water by the thermal energy produced by condensing of the steam, to keep the thermal energy supplied to the boiler relatively low.

In the method, the heating preferably comprises pre-heating of the incoming water by utilizing the thermal energy produced by the condensing, and is advantageously preceded by earlier pre-heating in which thermal energy is transferred from the condensed water to the incoming water. Particularly in the event that the incoming water is salt water, especially seawater, part of the heated water is returned to the source of the salt water, so tending to reduce the salinity of that water in the boiler which is not converted into steam. This has the advantage of avoiding excessive corrosion of the boiler and its associated parts through the corrosive effect of the salt. The impurity to be removed from the water may be other than salt. The method preferably includes, prior to the main, i.e. first-mentioned, pre-heating, pre-heating the incoming water by transferring thermal energy from that returning part to the incoming water. This has the advantages of not only reducing the thermal energy required for heating the boiler, but also of relatively reducing the heating of the water source by the returned part. Advantageously, the method includes compressing the steam prior to performing the main pre-heating. This has the advantage of promoting condensing of the steam in the performing of the main pre-heating. The main pre-heating may be such that, after start-up and during normal operation, it produces a mixture of hot water and steam, with a result that replacement water is drawn in from the source of incoming water. Advantageously, a suction pump is used to purge air from the condensed water.

The apparatus preferably comprises a pre-heating heat exchanger in a flow path of the incoming water to the boiler, the arrangement being such that thermal energy from the condensing steam can be employed to pre-heat the incoming water in the heat exchanger. The apparatus may advantageously comprise a second pre-heating heat exchanger upstream of the main heat exchanger in the flow path of the incoming water and in the flow path of the condensed water from the condensing arrangement, for transferring thermal energy from the condensed water to the incoming water. This has the advantage of making the apparatus more efficient from the point-of-view of its consumption of heating energy. The apparatus may include ducting whereby part of the heated water in the boiler is returnable to a source of the incoming water. Furthermore, the apparatus may further comprise a further pre-heating heat exchanger in that ducting and upstream of the main heat exchanger in the path of the incoming water for transferring thermal energy from the returnable part to the incoming water. Advantageously, the condensing arrangement comprises a compressor in the flow path of the steam upstream of the main heat exchanger for compressing the steam. Also advantageously, the apparatus includes a suction pump downstream of the main heat exchanger in the flow path of the condensed water for purging air from the condensed water. The apparatus may include a condensed water tank downstream of the main heat exchanger in the flow path of the condensed water and having an upper part thereof connected to the inlet side of that suction pump. The apparatus may further include a condensed water pump downstream of that condensed water tank and upstream of the second heat exchanger in the flow path of the condensed water. Advantageously, the boiler is in the form of a unit comprising a casing having an inlet for incoming water from the main heat exchanger, an outlet for the steam, and a housing extending into the casing for receiving an immersion heater. This has the advantage of facilitating installation of the boiler and its fluid connection to other items in the system. The casing may have also an outlet for that part of the heated water which is to be returned to the source.

In order that the invention may be clearly and completely disclosed, reference will now be made, by way of example, to the accompanying drawings, in which:

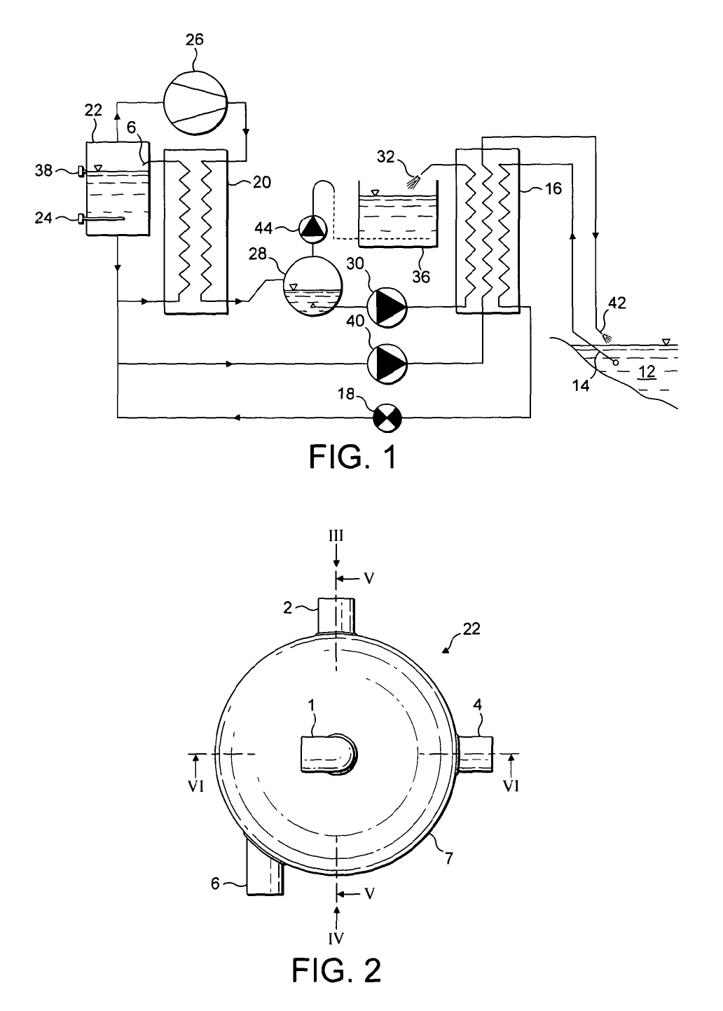

FIG. 1 is a diagrammatic representation of a system for desalination of seawater;

FIG. 2 is a plan view of a unit of the system;

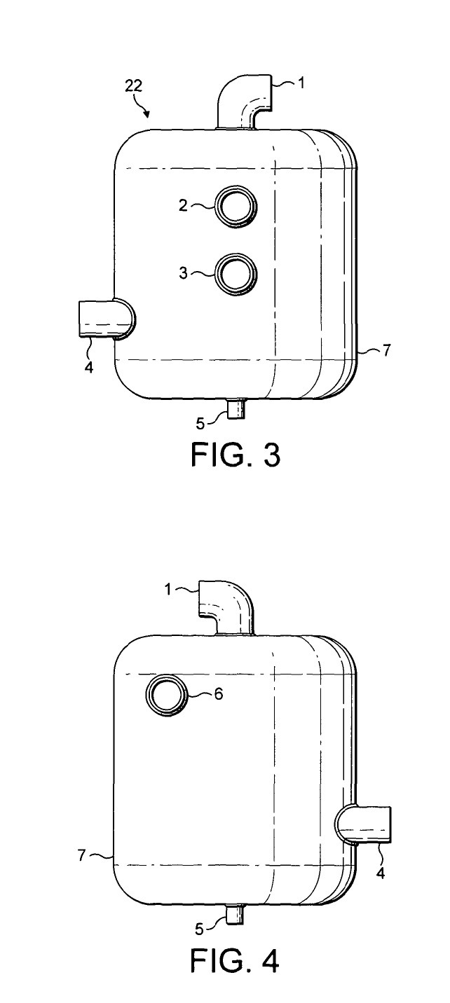

FIG. 3 is a side elevation of the unit taken in the direction of the arrow III in FIG. 2;

FIG. 4 is a side elevation of the unit taken in the direction of the arrow IV in FIG. 2;

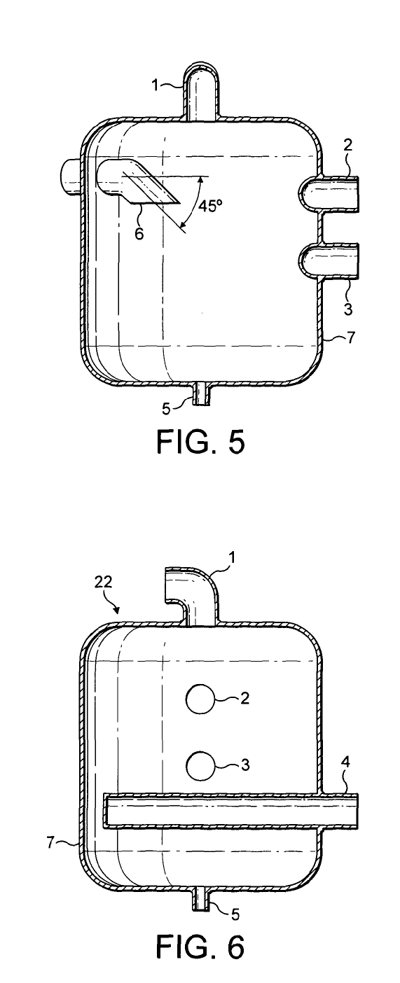

FIG. 5 shows a vertical axial section taken on the line V-V of FIG. 2; and

FIG. 6 shows a vertical axial section taken on the line VI-VI of FIG. 2.

Referring to FIG. 1, seawater 12 is drawn into the system through an inlet 14 to a heat exchanging arrangement 16 and then through a valve 18 and a heat exchanging arrangement 20 to a boiler/separator 22 in which, for start-up of the system, the seawater is heated by an immersion heater 24 to produce steam, but, during normal operation of the system, seawater in a mixture of hot seawater and steam produced in the arrangement 20 and delivered via an inlet 6 to the boiler/separator 22 is separated out from the steam. The steam is compressed by a compressor 26 in the form of a high pressure fan and fed to the heat exchanger 20 so that it condenses and the, condensed water so produced is fed to a condensed water tank 28. From the tank 28, the condensed water is pumped by a condensed water pump 30 via the heat exchanging arrangement 16 and an outlet 32 into a distilled water reservoir 36. The level of the seawater in the boiler 22 is kept substantially constant by means of a level sensor 38 which controls the opening and closing of the valve 18. After start-up, the separated-out hot seawater in the boiler 22 is continually returned to the source 12, by a returned water pump 40 controlled by the sensor 38, through the heat-exchanging arrangement 16 and an outlet 42. A vacuum pump 44 in communication with the upper part of the condensed water tank 32 purges air therefrom. If the air might contain water vapour, then the vacuum pump may forward the mixture of air and water vapour to the bottom of the distilled water in the reservoir 36, as indicated by chain lines in the Figure.

The boiler/separator 22 is in the form of the unit shown in FIGS. 2 to 6 readily connectible, from a fluid-flow point-of-view, into the remainder of the system. The unit comprises a cylindrical casing 7 having a substantially vertical axis. The casing has an outlet 1 for the steam, a housing 2 for receiving a sensor (not shown) for a safety maximum seawater level control of the pump 40, a sensor 3 for normal seawater level control, a housing 4 extending into the casing 7 for receiving the immersion heater 24, an outlet 5 for the returnable part of the heated water in the casing 7, and an inlet 6 which is for the seawater and steam mixture likely to be received from the heat exchanging arrangement 20 and which, as shown in FIG. 5, introduces the seawater and steam mixture downwardly and obliquely towards the level of the water in the casing 7, so as to achieve a good separation of the mixture of seawater and steam generated in the heat exchanger 20. The oblique, downward angle of introduction is preferably 45°, as illustrated in FIG. 5.

The operation of the system described above with reference to the drawings is as follows:

The vacuum pump 44 is started and creates a negative pressure down to about 500 hPa absolute. The valve 18, which may be in the form of a solenoid valve or a motor-controlled valve, opens and seawater is drawn in because the suction created by the pump 44 is transmitted via the fan 26, the boiler/separator 22, the valve 18 and the heat-exchanger 16 to the inlet 14. The seawater is drawn in via the inlet 14 and the heat-exchanging arrangement 16 until the seawater level in the boiler/separator 22 rises to that of the sensor 38. The seawater side of the heat-exchanging arrangement 20 automatically fills up to the same level. The immersion heater 24 starts to heat the seawater in the boiler/separator 22. The high-pressure fan 26 starts up once the temperature in the boiler/separator 22 attains approximately 60° C. and discharges steam which condenses in the distilled water side of the heat-exchanging arrangement 20. After a while, thermal energy transfer from the condensed water side of that arrangement 20 to the seawater side thereof begins, at approximately 75° C., to evaporate the seawater in the seawater side. A mixture of salt water and steam leaves the seawater side of the arrangement 20 and enters the boiler/separator 22. Circulation of salt water by convection from the boiler/separator via the outlet 5 to the seawater side of the arrangement 20 begins, in order to compensate for the evaporated water. The boiler/separator 22 thus automatically splits the liquid water and water vapour phases, which leave the boiler/separator 22 through the outlets 5 and 1, respectively. The water vapour, i.e. steam, is drawn off by the compressor 26 and the condensed water produced in the heat-exchanging arrangement 20 proceeds to the condensed water tank 28. The distilled water and returned water pumps 30 and 40 operate in sequence to drain distilled water from the condensed water tank 28 and part of the salt water out of the boiler/separator 22 back to the source 12. A typical ratio for the system is that, for every two parts of seawater drawn in, one part of distilled water is produced and one part of salt water is returned to the sea. During operation, air in the system is purged by the vacuum pump 40.

Owing to the use of the heat of condensation to evaporate the seawater, the power consumption of the system is relatively low. Surprisingly, tests carried out have shown that one kW/h of power consumed yields one ton of distilled water per day (24 hours).

1-24. (canceled)

25. A method of distilling water, comprising heating incoming water to produce steam, condensing the steam to produce condensed water and utilizing the thermal energy produced by said condensing to perform said heating.

26. A method according to claim 25, wherein said heating produces a mixture of hot incoming water and steam, said method further comprising separating-out the hot water and returning at least part of the separated-out water to a source of the incoming water.

27. A method according to claim 26 and further comprising recycling to said heating at least part of the separated-out water, said separated-out water being recycled by convection.

28. A method according to claim 25, and further comprising producing suction upon the condensed water the thermal energy from which is to be transferred to the incoming water.

29. A method according to claim 25, and further comprising a start-up phase in which incoming water is heated to produce steam and thermal energy is transferred from that steam to the incoming water to pre-heat the same.

30. Apparatus for use in distilling water, comprising a heating arrangement for heating incoming water and thereby producing steam, a condensing arrangement in a flow path of said steam from said heating arrangement for producing condensed water from said steam, the arrangement being such that thermal energy from the condensing steam can be employed to heat said incoming water in said heating arrangement.

31. Apparatus according to claim 30 and further comprising a pre-heating arrangement upstream of said heating arrangement in said flow path of said incoming water and in the flow path of the condensed water from the condensing arrangement for transferring thermal energy from the condensed water to the incoming water.

32. Apparatus according to claim 30, and further comprising ducting whereby at least part of the heated water from said heating arrangement is returnable to a source of said incoming water.

33. Apparatus according to claim 32, and further comprising a pre-heating arrangement in said ducting and in said path of the incoming water for transferring thermal energy from said at least part of the heated water to the incoming water.

34. Apparatus according to claim 30, wherein said condensing arrangement comprises a compressor in said flow path of said steam for compressing said steam.

35. Apparatus according to claim 30, and further comprising a suction pump in the flow path of the condensed water for purging air from the condensed water.

36. Apparatus according to claim 35 and further comprising a condensed water tank in the flow path of said condensed water and having an upper part thereof connected to the inlet side of said suction pump.

37. Apparatus according to claim 36, and further comprising a pre-heating arrangement upstream of said heating arrangement in said flow path of said incoming water and in the flow path of the condensed water from the condensing arrangement for transferring thermal energy from the condensed water to the incoming water, and a condensed water pump downstream of said condensed water tank and upstream of said pre-heating arrangement in said flow path of the condensed water.

38. Apparatus according to claim 30, wherein said heating arrangement comprises a separating chamber wherein hot incoming water is separable from a mixture of hot incoming water and steam and which has an inlet for said mixture, a water outlet for the separated-out water and a steam outlet for the steam.

39. Apparatus according to claim 38, wherein said inlet is downwardly directed.

40. Apparatus according to claim 39, wherein said inlet is obliquely downwardly directed.

41. Apparatus according to claim 30, wherein said chamber has a start-up heating device.

42. Apparatus according to claims 38 and further comprising ducting whereby at least part of the heated water from said heating arrangement is returnable to a source of said incoming water, and wherein said chamber has a water level sensor and a pump in said ducting controlled by said sensor for returning said at least part of the heated water to said source.

43. Apparatus according to claim 38, wherein said separating chamber is in the form of a unit comprising a casing having said inlet, said steam outlet and said water outlet.

44. Apparatus according to claim 43, wherein said unit has also a housing extending into said casing for receiving an immersion heater.
